(19) United States
(12) Patent Application Publication
(10) Pub. No.: US 2007/0282786 A1
(43) Pub. Date: Dec. 6, 2007

(54) PORTABLE DIGITAL AUDIO BIBLE

(75) Inventors: Andrew S. Block, New York, NY (US); Andy Rifkin, Rolling Hills Estates, CA (US); Brian Johannes, St. Louis, MO (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: The GoBible, LLC, New York, NY (US)

(21) Appl. No.: 11/691,786

(22) Filed: Mar. 27, 2007

Related U.S. Application Data
(60) Provisional application No. 60/800,533, filed on May 15, 2006.

(51) Int. Cl. G06F 17/30

(52) U.S. Cl. 707/1

(57) ABSTRACT

A portable dedicated audio Bible device is disclosed that includes an indexed and multi-formatted audio version of The Bible. A set of computer-executable instructions drive a user interface including an LCD. The user interface allows users to search and play the audio in a variety of ways, including, for example, at a verse level. Each of over 31,000 Bible verses of the audio content is individually stored in the portable dedicated audio Bible device. A user of the device selects an individually stored verse to begin play. All audio content is directly accessed via indexing tables. Furthermore, sets of indices are provided that are arranged to provide access to particular stories, topics, and pre-selected daily verse sequences.

### CROSS-REFERENCE TO RELATED APPLICATION

This application claims the priority benefit of Block, U.S. Provisional Patent Application Ser. No. 60/800,533, filed on May 15, 2006, entitled “PORTABLE AUDIO BIBLE DEVICE AND RELATED METHODS,” the contents of which are expressly incorporated herein by reference in their entirety, including any references therein.

### COPYRIGHT NOTICE

A portion of this disclosure contains material which may be subject to copyright protection. The copyright owner has no objection to the facsimile reproduction of the patent document or patent disclosure as it appears in the Patent and Trademark Office patent file or record, but otherwise reserves all copyright rights whatsoever.

### FIELD OF THE INVENTION

The present disclosure relates general to portable audio players, and more particularly, to audio players dedicated solely to rendering, via audio output, spoken versions of The Bible.

### BACKGROUND

For years hundreds of millions of people have sought guidance, reassurance, and comfort in The Bible. Technological innovation has allowed The Bible to be provided in spoken form via compact disc, audio tapes, and more recently via digital audio players. The known digital audio players include spoken digital audio copies of The Bible. In some cases, entire copies are stored on the devices, while others include only portions. Some are permanently configured while others can be updated to add/remove content.

A shortcoming of the known devices for playing audio versions of The Bible is their limited ability to select particular portions that are of particular interest to a user. For example, one such device allows a user to directly access a book or chapter. Thereafter, a user accesses a particular verse by playing the selected chapter containing, among other verses, the verse of interest. A significant amount of effort is therefore potentially expended by a user who wishes to access a particular verse or verses that are potentially located in multiple chapters.

Furthermore, accessing particular portions of interest in The Bible to a particular user requires the user to have a certain degree of prior knowledge of The Bible. However, many potential users of such devices unfortunately do not possess the requisite high degree of previous knowledge that would enable the user to find a portion of interest.

### SUMMARY OF THE INVENTION

An audio player device providing indexed direct access to particular verses of The Bible is described herein that addresses the inability of known audio players to provide adequate access to particular teachings/portions of The Bible. The digital audio Bible device includes a set of digital audio data segments that are stored in units, such as files, corresponding to Bible verses. The Bible furthermore includes a set of verse index entries that reference identified ones of the set of digital audio data segments. A set of play lists are also included in the device, wherein each play list specifies at least one sequence of verse index entries within the set of verse index entries. A user interface supports displaying names associated with the set of play lists. The device also includes a control module for accessing and processing specified ones of the set of digital audio data segments in response to a user selection, via the user interface, of a play list from the set of play lists.

The disclosure, in one implementation, is directed to a method of making passages of The Bible available for listening by a user. The method includes recording the passages as audio content. Each Bible verse of the audio content is individually stored in a portable audio device. A user of the device is allowed to select one of the individually stored verses for play.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a front view of a portable audio device in accordance with one implementation of the disclosure;

FIG. 2A is a schematic/functional block diagram including primary components of a portable audio device in accordance with an exemplary embodiment of the present invention;

FIG. 2B is a schematic data structure for a digital audio data segment structure used to store each verse of the digitally encoded audio Bible;

FIG. 2C is a schematic data structure for a Story index entry;

FIG. 2D is a schematic data structure for a Bible in a Year index entry;

FIG. 2E is a schematic data structure for a Topical index entry;

FIGS. 3A-3D are displays depicting exemplary user interfaces supported by the exemplary device to facilitate selection of particular sections of The Bible in a continuous play mode of operation in accordance with an exemplary embodiment;

FIGS. 4A-4D are exemplary displays depicting user interfaces supported by the exemplary device to facilitate selection and playback of digital audio data streams corresponding to a particular story of The Bible;

FIGS. 5A-5D are exemplary displays depicting user interfaces supported by the exemplary device to facilitate selection of and playback of digital audio data streams corresponding to a particular topic; and

FIGS. 6A-6F are exemplary displays depicting user interfaces supported by the exemplary device to facilitate selection of and playback of digital audio data streams corresponding to a particular week/day combination.

### DETAILED DESCRIPTION OF THE DRAWINGS

Referring to the Figures, an exemplary portable audio Bible device is disclosed. The audio content is, by way of example, arranged and indexed in a manner allowing a user to access portions of a digital audio version of The Bible at the verse level. In an exemplary play mode, upon completing the verse, the digital audio player continues to play the verses from the selected point (verse) forward. In other play modes, such as a story selection play mode, the device discontinues playing a series of verses and returns to a higher-level (e.g., story selection) menu display state upon completing a set of verses for a selected verse sequence (e.g., story). In an exemplary embodiment various play modes for processing selectable sequences of verses played sequentially as a group include: a set of verses grouped within a particular topic/theme, a particular selected sequence within a listing of sequences within daily set of readings, a story, a chapter, a book, etc.

In accordance with an aspect of an exemplary embodiment, groups of verse sequences, the beginnings/endings of which are referenced at a verse level of granularity, are arranged according to various grouping/indexing schemes. In a first example, sets of verse sequences are grouped according to various topics/themes (e.g., courage, forgiveness, bereavement/grief, hope, etc.). In a second example, the sets of verse sequences of The Bible are divided and assigned to days of a year. In a particular example, sequences of verses are assigned to particular days of the year associated with particular observed events (e.g., Easter, Christmas, etc.). In the exemplary embodiment the menu interface supports displaying a list of directly selectable verse sequences associated with each topic or week/day-of-week combination. Thus, the grouped sets verse sequences maintained in daily and topical indices of the exemplary portable audio embodiment are accessible by a user, after selecting a particular topic or week/day combination, and wherein the beginning of each sequence is at a verse level of granularity.

The Figures and associated written description also disclose a method of making verses of The Bible available for listening by a user through a dedicated portable device wherein the audio version of The Bible is preloaded and indexed at a verse level by various access/operating modes on the device during manufacturing. In the illustrative embodiment over 31,000 verses of The Bible are recorded as audio content, and each digitally encoded (for audio playback) verse audio segment is individually/directly referenced by an entry within an index/reference table maintained within the portable audio device. An associated menu interface on the portable audio Bible device supports displaying the individually/directly referenced verses and verse sequences for selection by a user. Upon sensing a user selection the device commences playback of the stored audio data at the user-selected verse or verse sequence.

In a direct verse selection mode of operation (hierarchical progressive selection of a book/chapter/verse combination), a user of the portable audio device selects, at a verse level of particularity, any one of the individually/directly referenced stored/indexed verses for play via the portal audio Bible device's menu interface. Thereafter, the device processes/plays an audio segment corresponding to the selected verse and, upon completion of the selected verse, continues playback of subsequent verse audio segments from the digitally encoded audio Bible device. In an operational mode, an onscreen display indicates the book, chapter and verse currently accessed/playing on the device. The displayed information is stored, for example, in the form of alphanumeric string data in a header included with each stored audio data segment corresponding to a verse. In operation, the display of the device changes to present a alphanumeric string corresponding to the currently accessed/playing verse audio segment. Thus the portable audio Bible device enables a user to search for and play back a particular verse (and subsequent sequentially arranged verses) within a digitally encoded portable audio Bible device. Such particularized selection of particular points within an audio recording of The Bible is facilitated by storing the audio data of The Bible as a set of verse audio segments within a memory of the devices, and creating a table of references to locations/addresses in the memory corresponding to the beginning of each verse audio segment. In a particular embodiment, each verse audio segment is stored in a data structure containing a header and a digital audio data stream corresponding to a verse of The Bible. The storage/indexing of the digital audio content (data streams) and methods of accessing the content at a verse level of granularity is described further herein below.

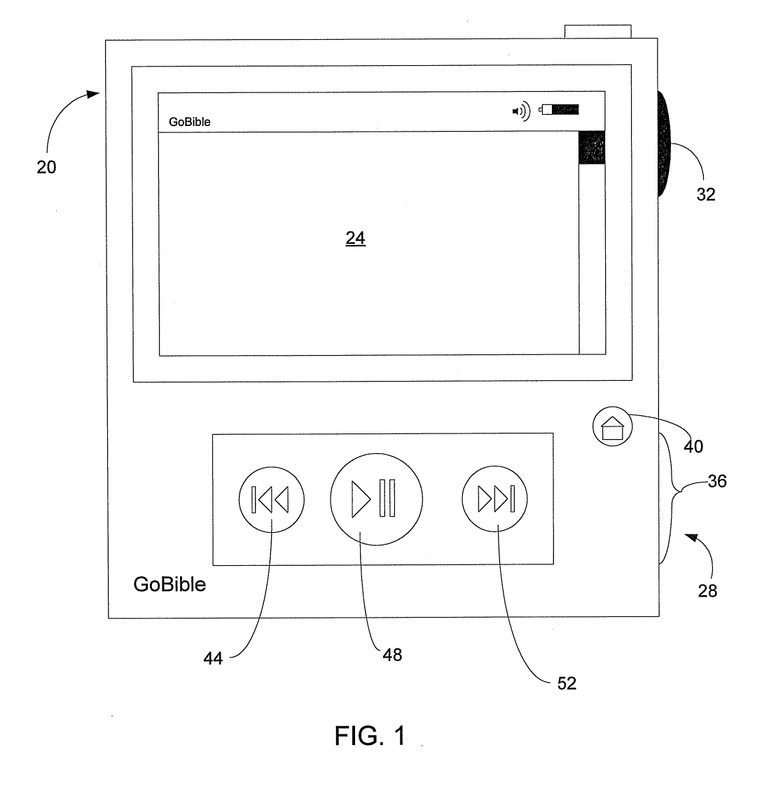

FIG. 1 illustratively depicts an exemplary portable digital audio device 20 for providing a digitally encoded audio version of The Bible. The illustratively depicted device is intended to be exemplary and is in no way intended to limit the scope of the invention. In alternative embodiments multi-function buttons associated with a multi-mode user interface enable a user to selectively access a desired portion of the digitally encoded audio version of The Bible in a variety of ways. The device 20 is a small (e.g., pocketsize) device that contains an audio version of the Christian Bible. The device 20, which can be handheld, includes a display 24, e.g., a liquid crystal display (LCD), and user controls indicated generally as 28 (e.g., a scroll wheel 32 and control buttons 36). In alternative implementations a directional pad (D-pad) replaces the scroll wheel 32. Buttons 36 include a home button 40, rewind button 44, play button 48, and fast-forward button 52. The device 20 also includes volume controls (not shown). The user controls 28 are exemplary, and other or additional user controls, including but not limited to toggle buttons, joysticks, D-pads and/or touch screens are incorporated into alternative embodiments of the device 20. In the illustratively depicted implementation the device 20 has an audio port, battery and AC adapter (not shown) and potentially includes one or more headphones. The device 20 also incorporates, by way of example, a short-range FM transmitting device (not shown) that allows the accessed digitally encoded audio content of the device 20 to be output via a particular channel of a car stereo having an FM receiver.

Using the scroll wheel 32 (alternatively a D-pad) in interaction with the LCD 24, a user designates for play the various books, chapters and/or verses of the Old and/or New Testaments. The user interface of the device 20 also supports users scrolling through and selecting from a story index of, for example, approximately 200 Bible stories and psalms. Many stories of The Bible begin at a verse level and, in the exemplary embodiment of the device 20, are indexed for direct access/selection at the verse level. Furthermore, as noted previously above, the device 20 includes a topic index and daily readings index including sets of verse sequences.

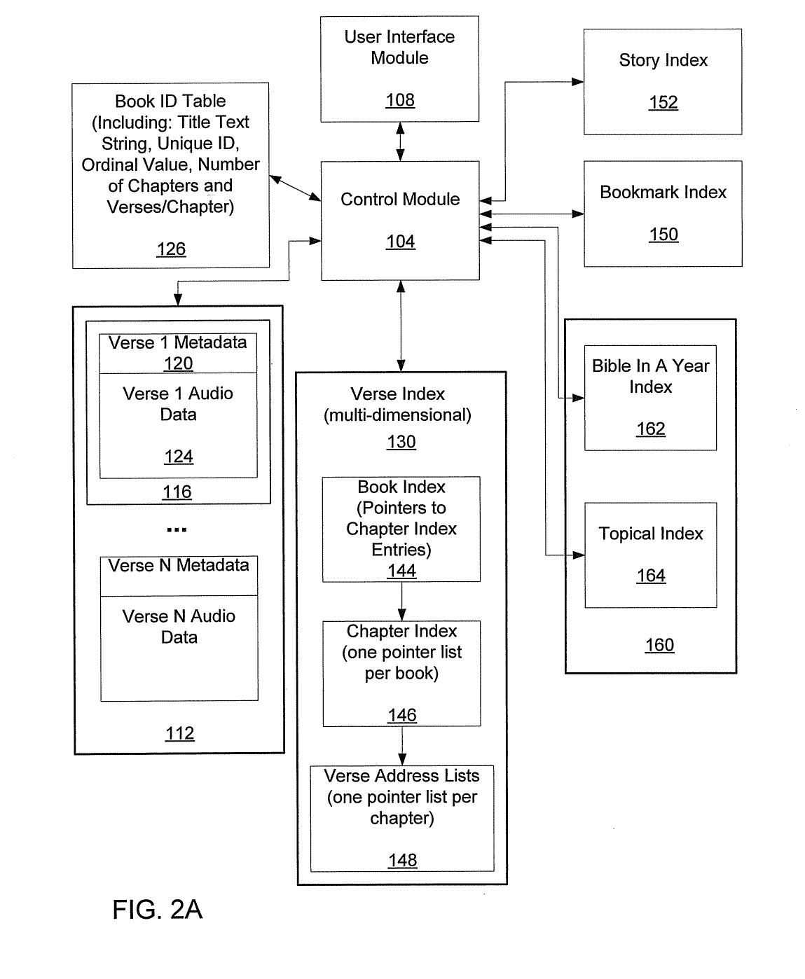

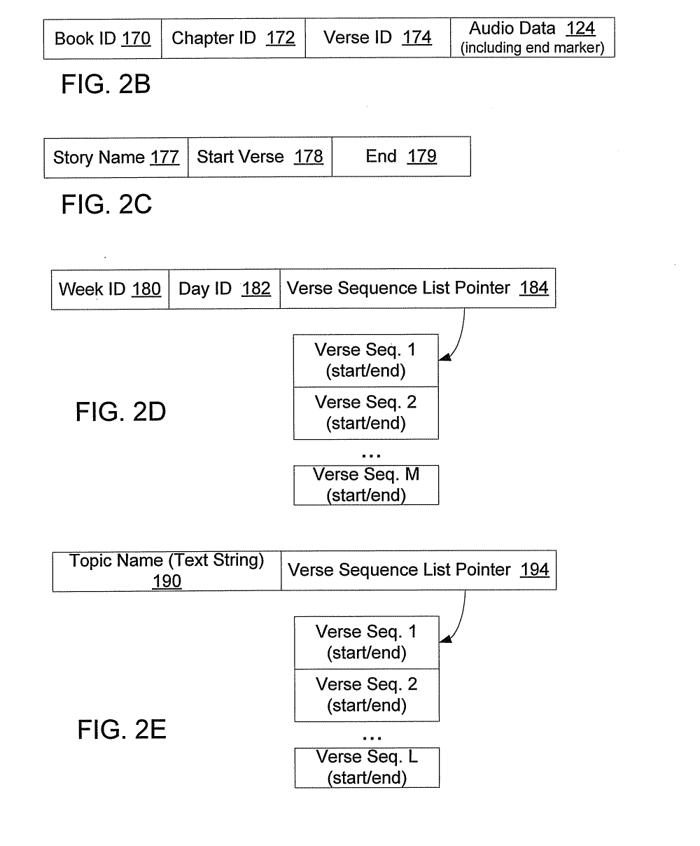

Turning to FIG. 2A, a schematic diagram of functional internal components of the portable device 20 (indicated generally in FIG. 2A by reference number 100) is depicted. The device 20 includes a control module 104. The control module 104 is, by way of example, hardwired/programmed sequential logic, a processor, included in a processor, and/or communicates with a processor. The control module 104 is communicatively connected, either directly/indirectly, to a variety of I/O components of the device 20 represented as a user interface module 108 for controlling and/or monitoring, for example, the LCD 24, user controls 28 and analog output audio signaling capability of the device 20. The control module 104 and interface module 108 are, in exemplary embodiments, contained in a single physical module. The control module 104 and interface module 108: drive/update a display state/appearance of the LCD 24, receive and process user input, and decompress and play audio files as further described herein below. It will be understood by those knowledgeable in the art that there are many ways in which control and user interface functions are programmed, configured and performed in devices such as the portable device 20. Accordingly, as used herein, the terms “module” and/or “device” refer, by way of example, to digital/analog circuitry incorporated into an application-specific integrated circuit (ASIC), an electronic circuit, a processor and memory that execute one or more software or firmware programs, a combinational logic circuit, and/or other suitable components, known to those skilled in the art, that provide the described functionality.

The device 20 includes a memory 112 into which a set of N digital audio data segments, such as a digital audio data segment 116 for “verse 1”, are pre-loaded. The N digital audio data segments correspond to a set of N digitally encoded audio verses of The Bible, stored in any of a variety of forms. In an exemplary embodiment (see, FIG. 2B), the verse digital audio data segments are stored as multi-field digital data sequences including a metadata portion 120 and a digital audio data portion 124 that includes an end of audio data segment (verse) marker. The digital audio data segment is stored in the memory 112 in the form of a file or virtually any of a variety of other data structures. The physical structure of the memory 112 comprises, for example, a flash memory device. In alternative implementations the memory 112 comprises any of a variety of read-only memory (ROM) or writeable memory devices. In some embodiments the digital audio data segments are stored in verse order within the memory 112. However, in an exemplary embodiment described herein below, a verse index 130 and associated indexes such as indexes 144, 146 and 148 enable the digital audio segments to be stored in any order and enable the control module 104 to play the verse audio files out of sequence and in any playing order.

In the exemplary embodiment, each digital audio data segment, such as audio segment 116, includes a metadata portion (e.g., metadata portion 120). The metadata portion describes the audio data segment's content (described further herein below with reference to FIG. 2B). A digital audio data portion, such as digital audio data portion 124, contains a digitally encoded audio data stream corresponding to a spoken verse from The Bible. The end of verse/audio data segment marker (not shown in FIG. 2A) marks an end point of a digital audio data portion of a digital audio data segment. The digital audio encoded version of The Bible is thus stored as a set of N digital audio data segments in the memory 112 wherein each one of the N digital audio segments corresponds to a single Bible verse. In an illustrative embodiment, the N digital audio segments are stored in any suitable order (e.g., one that facilitates compact storage of the segments), and the starting address of each digital audio data segment is maintained in the verse index 130 (described further herein below).

Turning briefly to FIG. 2B, a schematic drawing summarizes a set of fields in a data structure arranging text and digital audio data for a digital audio data segment (e.g., digital audio data segment 116). By way of example, the metadata portion 120 of digital audio data segment 116 includes a book ID field 170 uniquely identifying a book (e.g., Genesis) of The Bible. In an exemplary embodiment, rather than store the complete text string for each book in various locations each book title is stored only once in a Book ID Table 126 (see, FIG. 2A) along with a variety of other information driving the graphical/text displays of the user interface for the device (including a listing of chapters in each book and a number of verses contained in each chapter of a book). For each book title text string entry stored in the Book ID Table 126, a corresponding unique book ID is generated and stored for the entry. In an exemplary embodiment, the value stored for a particular book in the book ID field 170 is generated from a truncated (modulo) sum of the ASCII text values of at least a portion of a text string comprising the book name. In the exemplary embodiment, the book ID field 170 stores the unique ID generated from the ASCII text values for a particular book of The Bible. Furthermore, in the illustrative embodiment, an ordinal position is assigned to each book. Such position is either implicitly assigned based on the position of the entry in the set of book entries in the Book ID Table 126, and/or explicitly established by a numerical value stored with each book entry in the Book ID Table 126 or by an explicit offset address in memory.

The metadata portion 120 also includes a chapter ID field 172. The chapter ID field 172 stores a numerical value corresponding to the chapter number of a stored verse in the memory 112. A verse ID field 174 stores a numerical value corresponding to the verse number of a stored verse in the memory 112. The combination of identification data in the book ID field 170, chapter ID field 172 and verse ID field 174 uniquely identify a particular Bible verse's digital audio data stream stored in a corresponding digital audio data portion 124 of one of the N audio segments stored in the memory 112. In an exemplary embodiment, the book ID 170, chapter ID 172 and verse ID 174 comprise encoded alphanumeric text characters that are displayed as each corresponding verse is played by the device 20. The metadata portion 120, in an alternative embodiment, also includes a play time length for the audio verse. The metadata portion 120, in alternative embodiments includes any of a variety of other information pertaining to/characterizing the associated digital audio verse data stored in the digital audio data portion 124. Furthermore, the above scheme for identifying particular verses and their characteristics in the metadata portion 120 of each of the N digital audio data segments (e.g., digital audio data segment 116) is exemplary, and the identification scheme differs in alternative embodiments of the invention.

Returning to FIG. 2A the device 20 includes set of indexes/tables facilitating identifying locations of particular digital audio segments in the memory 112 corresponding to selected verses from The Bible. The Book ID Table 126 as noted previously above includes, for each Book entry, a Book ASCII text string, ordinal value, and unique book ID value (mentioned herein above). The ordinal value assigned to a particular book is one of three addressing components used to access a particular verse address entry in a verse index 130. In an exemplary embodiment, each Book entry includes a description of the number of Chapters and the number of verses within each Chapter. These values, in addition to driving the user interface that facilitates selecting a particular verse from The Bible, also drive the control module's retrieval of information from the Verse index 130 (during continuous play mode) by specifying a last verse of each Chapter and a last Chapter of each Book.

The verse index 130 stores a set of N address (pointer) entries corresponding to the locations of the N digital audio data segments stored in the memory 112. The verse index 130 is provided, for example, in a read-only memory (ROM), a flash memory or other appropriate storage medium. With regard to the content of the address entries in the verse index 130, each of the N verse address entries includes a value specifying a location in the memory 112 of the start of a corresponding one of the digital audio data segments, such as the digital audio data segment 116. In an exemplary embodiment, each of the address entries specifies a direct physical memory address for the starting point of a corresponding one of the digital audio data segments. In alternative embodiments other address specification methods are used. Examples of such alternative addressing schemes include specifying an offset from a start of memory containing the digital audio data segments. While the primary function of the address entries of verse index 130 is to specify a location of a corresponding digital audio data segment, in alternative embodiments additional data characterizing the corresponding verse, such as the metadata stored in the digital audio data segments of the memory 112, is included in additional fields of each of the address entries.

The individual address entries of the verse index 130 are arranged/accessed in a variety of ways in accordance with various embodiments of the invention. In an exemplary embodiment, the verse address entries, including verse address entry 134 containing the address pointing to the “verse 1” digital audio data segment 116, are arranged/accessed according to a three-dimensional addressing scheme based upon a combination of: an ordinal position assigned to each book, a chapter number, and verse number. Each combination of book ordinal and chapter number accesses a set of verse entries corresponding to the verses of the particular book and chapter combination. Each of the verse entries, in turn, specifies an address. In an exemplary embodiment, indirect addressing is used to ensure a compact memory design for the verse index 130. Thus, the verse index 130 includes an array of book pointers (referred to in FIG. 2A as Book Index 144), arranged according to book “ordinal” values assigned to each of the books. Each book pointer specifies an address of an array of chapter pointers (Chapter Index 146) corresponding to the set of chapters in each book. Each chapter pointer specifies an address of an array of verse pointers (Verse Address Lists 148) corresponding to an associated set of verses. The addresses specified by the verse pointers correspond to the locations of corresponding digital audio data segments in the memory 112. This hierarchical, indirect verse address storage scheme is exemplary and not intended to limit the present invention.

Alternatively, rather than using a multi-dimensional addressing/accessing scheme for the verse index, the N verse address entries in the verse index 130 are sequentially ordered based upon the order in which their corresponding verses are presented in The Bible. The sequential ordering of entries in the verse index 130 contrasts with the ordering of digital audio data segments in the memory 112—which can be in virtually any order.

With continued reference to FIG. 2A, as shown in drawing, the control module 104 is communicatively linked to the memory 112 and the various indices (e.g., the verse index 130 including book index 144, chapter index 146 and Verse Address Lists 148) storing relevant information for accessing particular digital audio data segments for verses in the memory 112. Based upon selection/play commands received by the control module 104 via the user interface module 108, the control module 104 accesses the verse address entries in the Verse Address Lists 148 to access, decode, and output the digital audio data for one or more corresponding digital audio data segments stored in the memory 112. The control module 104 accesses verse digital audio data segment addresses in the memory 112 provided by selected ones of the verse address entries in the Verse Address lists 148 of the verse index 130 to retrieve digital audio data stream data from corresponding digital audio data segments (e.g., digital audio data segment 116) for output/display via the user interface module 108. Because each associated digital audio verse data stream stored in the digital audio data portion for a specified one of the digital audio data segments can be selected/accessed individually, selected verse(s) can be accessed directly and played in a sequence that differs from the conventional order of the verses in The Bible.

A story index 152 includes a set of story entries corresponding to particular stories (e.g., Cain and Abel) in The Bible. The entries in the story index 152 specify sequences of particular digital audio data segments (verses) in the memory 112 to be accessed via the verse index 130. In an exemplary embodiment, the story index 152 is a table including a set of entries corresponding to a set of stories. Turning briefly to FIG. 2C, in an exemplary embodiment each story entry in the story index 152 includes: a story name 177, a start point 178 (first verse), and an end point 179 (last verse or run length identifying a number of sequential verses to be played from the specified start verse). In an exemplary embodiment, the story name 177 specifies an alphanumeric string of characters. The device 20 displays the string, along with other stories, when a user selects a story list option on the device 20's menu structure (discussed further herein below). The start point 178, by way of example, specifies a combination of a book ID, chapter number, and verse number corresponding to the beginning point of a story identified in the story name field 177. The end point 179 specifies a last verse of a story. In an embodiment, the last verse is specified by a value corresponding to the number of consecutive verses in a chapter for a particular story. Alternatively, an end point for a story is specified by verse number.

In addition to the pre-designated indexes containing permanent references to particular verses of The Bible, the device 20 includes a user-writeable bookmark index 150. The user-writeable bookmark index 150, by way of example, includes entries simply including a value corresponding to a physical address of the beginning of a digital audio data segment (e.g., segment 116) for the bookmarked verse in the digital audio data memory 112. The Book ID, chapter ID and verse ID specified by the digital audio data segment (see, FIG. 2B) are used by the control module 104 to access a next verse entry in the verse index 130 upon completion of the bookmarked verse (in a continuous play mode). The device 20 includes a bookmark function whereby a user designates/marks a verse in The Bible, referenced by a verse entry (e.g., physical memory location of the digital audio data segment) within the verse index 130, for later reference. When a bookmark is designated by a user at the verse level a corresponding entry is created in the bookmark index 150, and a verse identification text string is displayed in a bookmark menu. When a previously registered bookmark is selected from the bookmark menu, the device 20 accesses the corresponding entry in bookmark index 150 (that, in turn, references an entry from the verse index 130) to obtain the location of a corresponding one of the digital audio segments in the memory 112 and commences processing the stored digital audio data portion of the corresponding digital audio data segment. A plurality of bookmarks are supported, the number of which is dependent on size of memory in the device 20 allocated to the bookmark index 150 and/or reasonable limits on the size of a bookmark list. The physical memory containing the bookmark index 150 is erasable/re-writable to allow re-designation of the contents of the index 150.

Having described the basic components and operation of an exemplary digital audio device including digital audio data segments indexed at a verse level of granularity, attention is directed to enhancements to the base system described herein above. Returning to FIG. 2A, in accordance with an enhancement to the device 20, a set of one or more composite indices 160 are provided that include sets of references to particular verse sequences. As will be shown by way of various examples herein below, the composite index feature supports organizing sequences of the verses into verse sequence sets (including multiple verse sequences specified by start/stop points) that are presented as a logical set of a user via the display of the device 20.

In accordance with a first aspect the enhanced embodiment of the device 20, the composite indices 160 include a “Bible in a Year” index 162. The Bible in a Year index 162, by way of example, comprises 364 (52 weeks×7 days) sets of verse sequences. In the exemplary embodiment the sets of verse sequences are identified by a week (e.g., 1-52) and day (e.g., 1-7) combination. Thus, as illustratively depicted in FIG. 2D, each entry in the Bible in a Year index 162 includes a week ID field 180 and a day ID field 182. Thereafter, each week/day combination entry includes a pointer 184 to a set of verse sequence descriptor pairs identifying the start/end verse of each verse sequence for the particular week/day combination. The start is identified by Book ID, chapter number, and verse number. The sequence end is identified by a verse run length, or alternatively a value identifying the last verse. In the illustrative embodiment depicted in FIG. 2D, a set of M verse sequences are defined by linked list of M verse sequence descriptor pairs.

In a particular embodiment, the verses of The Bible are divided and assigned to the particular week/day combinations without any verse being repeated. However, in alternative embodiments verses are repeated on multiple days and/or not represented at all in the Bible in a Year index 162. In a particular embodiment the sets of verses within the Bible in a Year index 162 are associated with specified days of the calendar year. Furthermore, the Bible in a Year index 162 is broken into various other logical groupings such as, for example, a set of 52 play lists assigned to particular weeks of the year, and wherein each play list comprises a set of verse sequences. In yet other embodiments, 365 entries are identified by a unique day identifier (rather than a week/day-of-week combination). Additional composite indices within the composite indices 160 are described herein below. Also, while the illustrative example uses verses to identify sequences, in alternative embodiments, the sequences are identified by specifying a particular chapter of a specified book.

The information associated with days 1-7 of an exemplary week from the Bible in a Year index 162 is provided by way of example herein below. The information provided in the example represents a combination of information provided by entries within the Book ID Table 126 (Book name text strings), the Bible in a Year index 162 (verse sequences, and the relevant digital audio data segments in memory 112 (runtimes).

| DAY | BOOK/CHAPTER | TIME | TOTAL TIME |
|---|---|---|---|
| 1 | Genesis 1:1–1:31 | 5:10 | 12:29 |
| | Genesis 2:1–2:25 | 3:44 | |
| | Matthew 1:1–1:25 | 3:35 | |
| 2 | Genesis 3:1–3:24 | 4:13 | 12:40 |
| | Genesis 4:1–4:26 | 3:56 | |
| | Matthew 2:1–2:23 | 3:43 | |
| | Psalms 1:1–1:6 | :48 | |
| 3 | Genesis 5:1–5:32 | 3:18 | 12:46 |
| | Matthew 3:1–3:17 | 2:31 | |
| | Matthew 4:1–4:25 | 3:29 | |
| | Proverbs 1:1–1:33 | 3:28 | |
| 4 | Genesis 6:1–6:22 | 3:06 | 11:22 |
| | Genesis 7:1–7:24 | 3:08 | |
| | Genesis 8:1–8:22 | 3:13 | |
| | Proverbs 2:1–2:22 | 1:55 | |
| 5 | Genesis 9:1–9:29 | 3:54 | 11:57 |
| | Matthew 5:1–5:48 | 6:46 | |
| | Psalms 2:1–2:12 | 1:17 | |
| 6 | Genesis 10:1–10:32 | 3:18 | 11:53 |
| | Genesis 11:1–11:332 | 3:40 | |
| | Matthew 6:1–6:34 | 4:55 | |
| 7 | Genesis 12:1–12:20 | 3:02 | 12:10 |
| | Genesis 13:1–13:18 | 2:31 | |
| | Matthew 7:1–7:29 | 3:29 | |
| | Proverbs 3:1–3:35 | 3:08 | |

It is noted that while time durations are listed in the exemplary charts provided above, in other embodiments durations are not provided.

Alternatively, the Bible in a Year index 162 sequentially organizes the digital audio content of memory 112 according to the sequential ordering of the verses/chapters/books within The Bible.

In accordance with a second aspect of the composite indices 160, the device 20 includes a topical index 164 including a set of entries, and wherein each of the entries specifies sets of verse sequences associated with a particular topic (e.g., anger, courage, love, etc.).

The Topical index 164, by way of example, comprises multiple sets of verse sequences corresponding to a set of topics relating to emotions and situations in life. In the exemplary embodiment the sets of verse sequences are designated by a topic name and an associated set of verse sequences. Thus, as illustratively depicted in FIG. 2E, each entry in the Topical index 164 includes a topic name ID 190. Furthermore, in an exemplary embodiment, the topic name ID 190 comprises a text string corresponding to the topic name. Thereafter, each topical index entry includes a pointer 194 to a set of verse sequence descriptor pairs identifying the start/end verse of each verse sequence for the particular topic. The start is identified by a Book ID, chapter number, and verse number. The sequence end is identified by a verse run length, or alternatively a value identifying the last verse In the illustrative embodiment, a set of L verse sequences are defined by L sets of sequence descriptor pairs.

An exemplary listing of topics and associated verses designated within the Topical Index 164 are presented herein below.

### Afflictions

### 2 Cor. 4:16-18

### Psalms 55:1-8

### Mark 14:32-36

### Jonah 2:1-10

### Heb 12:11

### Anger

### Psalms 86:15-17

### Proverbs 16:32

### James 1:19-20

### Bereavement/Grief

### Genesis 37:34-35

### 2 Samuel 12:15-23

### Isaiah 61:1-3

### John 11:32-36

### Romans 8:38-39

### Christ's Love

### Mark 10:20-21

### John 15:12-13

### Rom 8:35

### Confidence

### Daniel 3:16-18

### Psalms 27:1

### 1 Cor 1:30-31

### 1 John 5:14

### Courage

### Psalm 31:24

### Mark 15:43

### John 16:33

### Despair

### Genesis 21:14-19

### Isaiah 40:27-31

### Jonah 2:1-10

### 2 Cor 11:8-10

### Love of Neighbor

### Leviticus 19:18

### Matthew 25:34-40

### Luke 10:25-37

### Love Your Enemies

### Matthew 5:43-48

In an exemplary embodiment, when a selected set of verses under a particular topic completes (i.e., is finished being played), control returns to a sub-menu presentation mode wherein the selected topic and set of options under the selected topic are displayed.

Furthermore, in accordance with exemplary embodiments, the content of the composite indices 160 is extensible/editable. In embodiments, a user edits the content of the composite indices 160 by, for example: (1) adding new indices, or (2) modifying an existing index. With regard to modifying an existing index, such modifications include: adding/editing verse sequences associated with an existing day/topic playlist and/or (2) adding a new set of verse sequences (e.g., topic, occasion, etc.) to an index.

Having described the general content and functionality of components that make up an exemplary embodiment of the device 20, attention is directed to the operation of the device and the interaction of the device 20 with users via exemplary display interfaces.

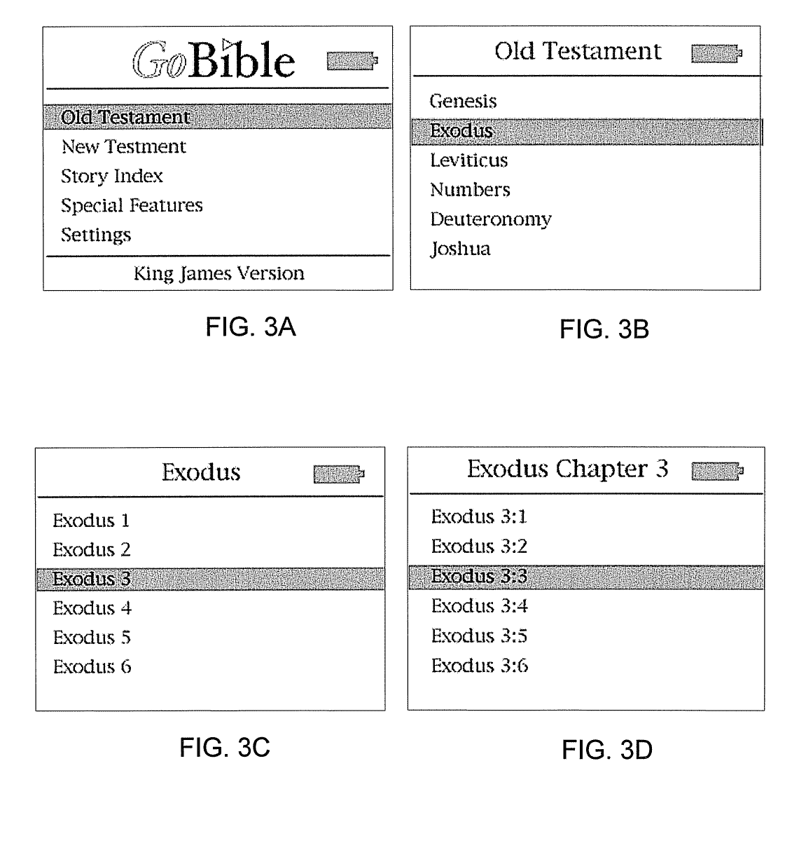

Exemplary displays presented by the LCD 24 indicating a selection sequence in accordance with one implementation of the disclosed device 20 are shown in FIGS. 3A-3D. As shown in FIG. 3A, a main menu is presented to a user which includes top-level features/access modes available for selection. Specifically, a user scrolls through Old Testament, New Testament, Story Index, Special Features, and Settings entries. The Old and New Testament options correspond to a hierarchical set of menus through which a user ultimately selects a particular Book, Chapter, and Verse from which to commence listening to verses.

### Continuous Play Modes (Old and New Testaments):

As shown in FIG. 3A, the user has selected the “Old Testament” from the displayed top-level menu. Next, as shown in FIG. 3B, the device 20 presents a scrollable list of the books contained in the Old Testament. In the example, a user has scrolled to the book of “Exodus”. Turning to FIG. 3C, upon selecting the “Exodus” entry, a list of chapters contained in the book of “Exodus” are displayed in a scrollable list. Upon selecting Chapter 3, as shown in FIG. 3D the device 20 presents a listing of verses within Chapter 3 of Exodus.

Upon selection of a verse (e.g., verse 3 of chapter 3) a continuous play mode commences. By way of example, the device 20 registers the user's selection and forwards the identified book/chapter/verse selection to the control module 104. The control module thereafter accesses a corresponding address entry in the verse index 130 to determine the location of the corresponding digital audio data segment in memory 112 and commences playing the designated verse. Furthermore, in accordance with an embodiment of the invention, a flag is set in the control module 104 specifying a continuous play mode. Therefore, upon completion of the selected verse (e.g., Exodus 3:3), the control module looks up the address for the digital audio segment for the next verse (e.g., Exodus 3:4) within the verse index 130 and plays the corresponding digital audio segment in memory 112. The sequencing logic within the control module, using the Book/Chapter/Verse information provided by the table 126 and the verse index 130, continues to access and play the verses sequentially (including commencing a next chapter when a previous chapter is completed and commencing a next book when a previous book is finished) until the user discontinues the play mode on the device 20 or the end of New/Old Testament of The Bible is reached. The selection hierarchy and play mode operation is similar for the “New Testament” top-level menu option/mode of operation.

It is noted that while a continuous play mode has been described for both the Old and New Testament menu options, in alternative exemplary implementations, when the user selects a single verse, only the selected verse is played. In yet other exemplary implementations, the control module 104 is configured to play a pre-designated number/logical grouping (e.g., chapter or book) of verses and to stop play after the set of verses has finished playing. In yet other exemplary embodiments, start and end points are user selectable at a verse level of granularity (e.g., Luke 1:02-Luke 1:20).

### Story Index Play Mode:

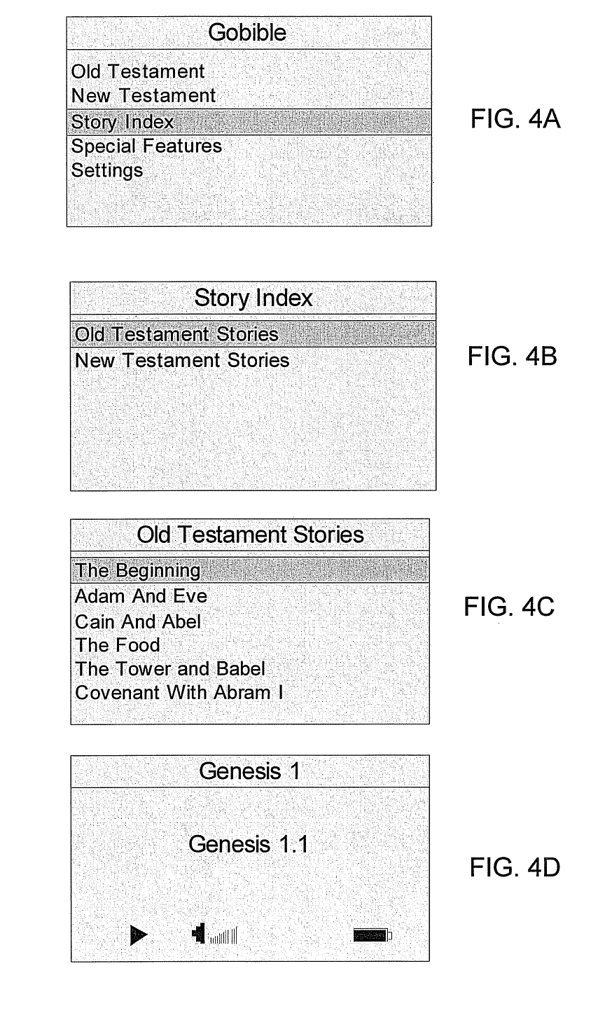

Referring again to FIG. 4A, when the user selects “Story Index” from the main menu 200, a second display offers access to stories from the Old and New Testaments (depicted by way of example in FIG. 4B). In response to a user selecting the Old Testament option, a scrollable chronological list of stories and psalms is displayed as shown by way of example in FIG. 4C. The text for each story name is retrieved from the story name field 177 of each story entry in the story index 152. Thereafter, upon selection of a story from the list depicted in FIG. 4C, the control module 104 accesses the start point (verse) 178 and end point 179 from the story index 152 and commences playing the first verse. The control module 104 accesses the beginning of the appropriate one of the digital audio data segments in memory 112 (through a particular verse address entry in the verse index 130 referenced by an entry in the story index 152 corresponding to the selected story) and begins playing a sequence of verses from the specified story's beginning point. Turning to FIG. 4D, while playing each of the sequence of verses, the device 20 displays the currently playing verse. Each story or psalm is directly accessible by the control module 104 for play based on the first verse in the story or psalm (referenced via a corresponding entry in the story index 152). In an exemplary embodiment, the control module 104 uses the value specified in the end point 179 to specify when a last verse of a story's sequence of verses has been accessed. At that point, a last verse flag is set which causes the control module to revert back to the story list mode (see, FIG. 4C) upon completion of the currently playing verse.

The Topical Index and the Bible in a Year play modes are accessed via the “Special Features” option on the top level menu depicted in FIG. 4A.

### Topical Index Play Mode:

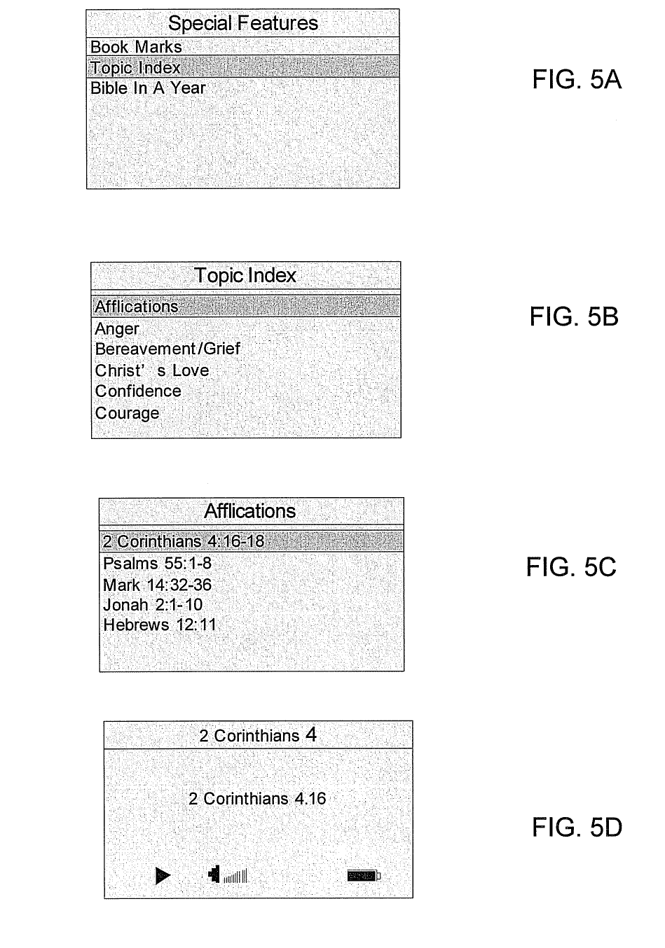

The topical entries are individually accessed by selecting a “Topic Index” menu option on the Special Features menu depicted, by way of example, in FIG. 5A. Selection, by a user, of the Topic Index invokes the control module 104 to present a scrollable listing of supported topics via the user interface module 108 and the LCD display interface of the device 20 as shown, by way of example, in FIG. 5B. The text for each topic name is retrieved from the topic name field 190 of each topic entry in the topical index 164.

Thereafter selection, by a user, of a particular one of the listed topics (e.g., Afflications) invokes the control module to access a particular entry in the topical index 164 corresponding to the selected topic. Each of the topic entries (see, FIG. 2E) is associated with a set of verse sequences. As shown, by way of example, in FIG. 5C, the module retrieves for display a list of verse sequences described in a list pointed to by the verse sequence list pointer 194 of the selected topic. Upon selection of a particular one of the displayed verse sequences, the control module 104 retrieves the corresponding start point and end point from the list of verse sequence descriptions referenced by the list pointer 194. Thereafter, the control module 104 accesses the beginning of the appropriate one of the digital audio data segments in memory 112 (through a particular verse address entry in the verse index 130 referenced by the specified starting verse of the selected verse sequence), and begins playing the designated sequence of verses. Turning to FIG. 5D, while playing each of the sequence of verses, the device 20 displays the currently playing verse. In an exemplary embodiment, when a last verse of a designated verse sequence has been accessed, a last verse flag is set which causes the control module to revert back to the verse sequence list mode for a selected topic (see, FIG. 5C) upon completion of the currently playing verse.

In an alternative embodiment, the control module 104 logic is programmed such that the digital audio content referenced by the verse sequence sets specified for a particular user-selected topic runs until the control module 104 has accessed and processed the last identified verse sequence of a selected topic (i.e., each of the corresponding ones of the digital audio data segments 116 has been processed by the device 20).

### Bible in a Year Play Mode:

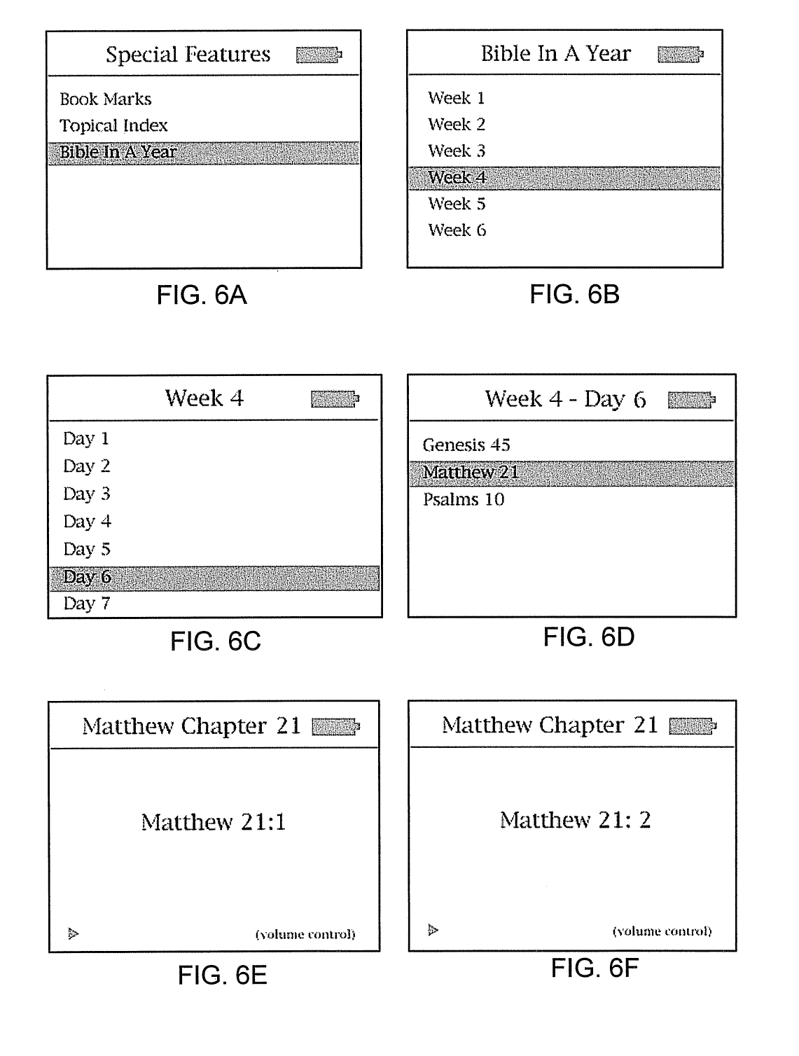

The daily entries associated with the Bible in a Year play mode are individually accessed by selecting a “Bible in a Year” menu option on the Special Features menu depicted, by way of example, in FIG. 6A. Selection, by a user, of the Bible in a Year Index invokes the control module 104 to present a scrollable listing of weeks via the user interface module 108 and the LCD display interface of the device 20 as shown, by way of example, in FIG. 6B. Next, after a user selects one of the weeks, a list of days are presented (see, FIG. 6C).

Each of the daily entries, as shown in the data structure depicted in FIGS. 2D and 6D, is associated with a set of verse sequences assigned to the particular day. Therefore, upon selection of a particular day, the control module retrieves from the Bible in a Year index 162 an associated set of verse sequences (identified by Book, chapter, and verse beginning/end). As shown in FIG. 6D, the set of sequences are presented on the user interface of the device 20. In the illustrative embodiment, each entry within a day corresponds to a selected chapter, and therefore a range of verses are not displayed on the exemplary user interface depicted in FIG. 6D. However, in alternative embodiments, a chapter and a range of verses (within the chapter) associated with an entry for a particular day are displayed.

Upon selection of a particular one of the displayed verse sequences, the control module 104 retrieves digital audio data segments from the memory 112 in accordance with the corresponding start point and end point from the selected one of the verse sequences referenced by the list pointer 184. The control module 104 accesses the beginning of the appropriate one of the digital audio data segments in memory 112 (through a particular verse address entry in the verse index 130 referenced by the specified starting verse of the selected verse sequence), and begins playing the designated sequence of verses. Turning to FIGS. 6E and 6F, while playing each of the sequence of verses, the device 20 displays the currently playing verse. In an exemplary embodiment, when a last verse of a designated verse sequence has been accessed, a last verse flag is set which causes the control module to revert back to the verse sequence list mode for a selected day (see, FIG. 6D) upon completion of the currently playing verse.

In an alternative embodiment, the control module 104 logic is programmed such that the digital audio content referenced by the verse sequence sets specified for a particular user-selected day runs until the control module 104 has accessed and processed the last identified verse sequence of a selected day (i.e., each of the corresponding ones of the digital audio data segments 116 has been processed by the device 20).

Finally, in an exemplary embodiment, during the playback of the verse sequences in any of the aforementioned play modes, a skip/repeat verse control supported by the user interface module 108 allows a user to skip to a next verse without playing the entire current verse or, alternatively, repeat a previously accessed verse starting from its beginning.

In operation, the control module 104 in the enhanced embodiment builds a play list identifying a selected verse sequence from a set of verse sequences associated with a week/day combination, a topic, or a story. The control module 104 sequentially accesses (through the verse index 130) and plays the corresponding digital audio content in the memory 112. Upon completion of the specified sequence of verses associated with a day, a topic, or story, the device 20 returns to an appropriate “parent” menu providing a listing of verse sequences for a selected day or topic or, a listing of stories based upon the currently designated mode of operation of the device 20. This contrasts with a continuous verse play mode wherein accessing and playing verses progresses sequentially without stopping until a stop signal is received by the control module 104 via the user interface module 108.

The present audio device will be appreciated by people who read The Bible often but want the convenience of listening in a car, plane or train or while walking. People who cannot read easily due to age and/or impaired sight also will appreciate the device. The device 20 is convenient to use and is user-friendly. The device 20 easily fits into the palm of a hand or a shirt pocket. The exemplary audio device 20 displays to a user the verse he/she is listening to and/or that a verse has ended and a new one has begun. Furthermore, the exemplary device 20 provides a user with the option of listening at the verse level. The device will be particularly useful to students and others who speak of and study The Bible at the verse level.

The structures, techniques, user interfaces and associated benefits discussed above are merely exemplary embodiments of the invention carried out by software executed upon a computer and stored on computer readable media in the form of computer executable instructions. In view of the many possible embodiments to which the principles of this invention may be applied, it should be recognized that the embodiments described herein with respect to the drawing figures are meant to be illustrative only and should not be taken as limiting the scope of invention. The illustrated embodiments can be modified in arrangement and detail without departing from the spirit of the invention. Moreover, those of skill in the art will recognize that the disclosed principles are not limited to any particular audio player technology. Therefore, the invention as described herein contemplates all such embodiments as may come within the scope of the following claims and equivalents thereof.

What is claimed is:

1. A digital audio Bible device including:
a set of digital audio data segments stored in units corresponding to Bible verses;
a set of verse index entries referencing identified ones of the set of digital audio data segments;
a set of play lists, wherein each play list specifies at least one sequence of verse index entries within the set of verse index entries;
a user interface supporting display of names associated with the set of play lists; and
a control module for accessing and processing specified ones of the set of digital audio data segments in response to a user selection, via the user interface, of a play list from the set of play lists.

2. The digital audio Bible device of claim 1 wherein each digital audio data segment includes a book ID, a chapter ID, and a verse ID.

3. The digital audio Bible device of claim 1 wherein the set of play lists includes a topical index including for each topic entry, represented by a text string presented to a user via the user interface, sequences of verse index entries corresponding to the topic represented by the text string.

4. The digital audio Bible device of claim 3 wherein each topic entry includes a verse sequence list specifying sets of verse sequences.

5. The digital audio Bible device of claim 1 wherein the set of play lists includes a calendar-based index including for each calendar entry, represented by a text string presented to a user via the user interface, sequences of verse index entries corresponding to the topic represented by the text string.

6. The digital audio Bible device of claim 5 wherein each calendar entry includes a verse sequence list specifying sets of verse sequences.

7. The digital audio Bible device of claim 1 wherein the set of play lists includes a story index including for each story entry, represented by a text string presented to a user via the user interface, a sequence of verse index entries corresponding to the story represented by the text string.

8. The digital audio Bible device of claim 7 wherein each story entry specifies a verse sequence.

9. The digital audio Bible device of claim 1 further comprising a bookmark index supporting designation, by a user, of particular verses of interest in the set of digital audio data segments stored in units corresponding to Bible verses.

10. The digital audio Bible device of claim 1 wherein individual entries of the set of verse index entries are identified by a combination of book, chapter, and verse identifiers.

11. A method of making passages of The Bible available for listening by a user, the method comprising:
recording the passages as audio content;
individually storing each Bible verse of the audio content in a portable audio device; and
providing a user interface allowing a user of the device to select one of the individually stored verses for play.

12. The method of claim 11 further comprising:
storing each verse in a first memory of the portable audio device; and
providing a memory address for each verse in an index in a second memory of the device.

13. The method of claim 11 further comprising:
storing an address for each of the stored verses in an index; and
configuring the audio device to use the index to play a verse selected by the user.

14. The method of claim 11 further comprising displaying information pertaining to the selected verse while the selected verse is playing.

15. A portable device for providing an audio version of The Bible, the device comprising:
a memory including a plurality of audio files, each file including a single verse of The Bible;
an index including a plurality of addresses for providing direct access to each of the audio files; and
a control module configured to:
based on input from a user of the portable device, use one of the index addresses to directly select a verse for play.

16. The portable device of claim 15 wherein each audio file is pointed to by a corresponding one of the addresses.

17. The portable device of claim 15 wherein the index comprises one or more addresses for providing direct access to one or more Bible stories.

18. The portable device of claim 17 further comprising a display, the control module further configured to use the display to allow a user to select one of the one or more stories for play.

19. The portable device of claim 15 further comprising a second memory in which the index is stored.

20. The portable device of claim 15 wherein the index comprises one or more addresses for providing direct access to one or more psalms.
